(19) United States
(12) Patent Application Publication
(10) Pub. No.: US 2023/0195080 A1
(43) Pub. Date: Jun. 22, 2023

(54) COMPOSITE INTELLIGENT DETECTION METHOD AND CUTTING APPARATUS

(71) Applicant: SUZHOU SENDING HIGH-END EQUIPMENT CO., LTD., Suzhou City, Jiangsu Province (CN)

(72) Inventors: ZENGYUAN NIU, Suzhou City, Jiangsu Province (CN); RENHUAN CHEN, Suzhou City, Jiangsu Province (CN); DEHONG HUO, Suzhou City, Jiangsu Province (CN); HUI DING, Suzhou City, Jiangsu Province (CN)

(21) Appl. No.: 17/912,867

(22) PCT Filed: Mar. 31, 2020
(86) PCT No.: PCT/CN2020/082353

§ 371 Date: Sep. 20, 2022

(30) Foreign Application Priority Data
Mar. 20, 2020 (CN) 202010200340.4

(51) Int. Cl. G05B 19/4155; B23Q 15/12

(52) U.S. Cl. CPC G05B 19/4155; B23Q 15/12; G05B 2219/37087

(57) ABSTRACT

The present invention relates to a composite intelligent detection method and a cutting apparatus. A cutting force F of a tool bit is obtained in real time by a force sensor; an inertia force F2 is obtained through detection in real time by an acceleration sensor and calculation; an actual cutting force F is calculated by F−F2 in real time; and a tool feed is calculated by integration on acceleration in real time. According to the composite intelligent detection method and the cutting apparatus in the present invention, the assembling difficulty and cost of the apparatus are reduced while the detection accuracy is relatively high.

This application claims the priority of CN Application No. 202010200340. 4 filed on Mar. 20, 2020 and titled “COMPOSITE INTELLIGENT DETECTION METHOD AND CUTTING APPARATUS”, which is incorporated herein by reference in its entirety.

### TECHNICAL FIELD

The present invention relates to the field of machining technologies, in particular to a composite intelligent detection method and a cutting apparatus for a fast tool servo (FTS) technology.

### BACKGROUND

When products are machined, a variety of machining technologies are required to facilitate molding of the products into required finished products. A fast tool servo mechanism using high-frequency cutting has the highest cutting efficiency and cutting accuracy in the field of the machining technologies. At present, most of the fast tool servo technologies only use displacement sensors to feed a cutting amount back rather than a cutting force, and thus, the cutting accuracy is decreased after a tool bit is worn. In view of this situation, Japanese scholars have made an improvement, that is, a force sensor is additionally provided to detect the cutting force of the tool bit and feed the cutting force back, such that the wear of the tool bit can be detected. However, the improved tool servo technology directly detects the force fed back in cutting through the force sensor, and readings of the force sensor include an inertia force of the mechanism. As a result, a real cutting force cannot be fed back due to the adverse influence of the inertia force of the mechanism. Thus, there is still a room to improve the accuracy of the fast tool servo technology.

In Japanese patent JP 4528937B2, a force sensor is disposed at an end of a cutting apparatus, and a measured cutting force F includes an actual cutting force F1 and an inertia force F2. Since the force sensor is located at the end of the cutting apparatus, the inertia force F2 is relatively large. Thus, the cutting force of a tool bit is greatly affected by the inertia force, resulting in failure of accurate reflection of the actual cutting force F1 through the cutting force F of the tool bit.

In a cutting apparatus disclosed in Chinese patent CN101456142A, a force sensor is disposed at a position close to a tool bit. Although the adverse influence of an inertia force F2 on readings of the force sensor is reduced, the adverse influence of the inertia force F2 cannot be eliminated as a value of the inertia force F2 cannot be detected. As a result, it is impossible to obtain an accurate value of an actual cutting force F1.

In the above two ways of estimating the actual cutting force by using a look-up table method according to the vibration frequency and vibration displacement at the position of the tool bit as well as the mass and other parameters of the tool bit in combination with the readings of the force sensor, the actual cutting force cannot be accurately fed back or cannot be fed back online in real time. Meanwhile, the existing fast tool servo technology uses a displacement sensor to feed a cutting amount back, while the mounting of the displacement sensor requires a high-accuracy fixture and complicated debugging. However, in the case of a micron-scale tool feed, a machining accuracy requirement of related matching parts for clamping the displacement sensor is very high, resulting in high machining cost. Moreover, it is required to calibrate an initial mounting position of the displacement sensor, resulting in relatively large calibration difficulty.

### SUMMARY

A technical problem to be solved by the present invention is to provide a composite intelligent detection method and a cutting apparatus for a fast tool servo technology, which can eliminate adverse influence of an inertia force through calculation, realize online feedback of an actual cutting force in real time, and meanwhile, measure and calculate a tool feed by an acceleration sensor, without needing high-accuracy calibration.

A technical solution adopted by the present invention to solve the technical problems thereof is as follows: a composite intelligent detection method is provided and configured to detect a cutting force and a tool cutting feed of a fast tool servo cutting apparatus. The method includes the steps of:

S1, detecting a cutting force of a tool bit, wherein the cutting force is directly acquired by a force sensor in the cutting apparatus;

S2, detecting an acceleration, wherein the acceleration is acquired by an acceleration sensor arranged in the cutting apparatus;

S3, calculating an inertia force, wherein the inertia force is obtained by acquiring a moving mass on the force sensor and calculating by Equation 1:

F2=M×a Equation 1,

wherein F2 represents the inertia force, M represents the moving mass, and a represents the acceleration;

S4, calculating an actual cutting force by Equation 2:

F1=F−F2 Equation 2,

wherein F represents the cutting force of the tool bit, F1 represents the actual cutting force, and F2 represents the inertia force; and

S5, calculating the tool feed, wherein the tool feed is obtained by performing integration operation on the acceleration.

Further specifically, the moving mass is a sum of masses of objects that are arranged between the force sensor and an object to be cut and that directly and indirectly act on the force sensor.

A cutting apparatus based on the method includes an annular base, a tool bit assembly arranged at one end of the annular base, and an annular piezoelectric actuator fixed inside the annular base and abutting against the tool bit assembly, wherein the tool bit assembly includes a flexible hinge fixed at an end of the annular base, an acceleration sensor fixed onto the flexible hinge, a force sensor fixed onto the flexible hinge, and a tool bit arranged on the force sensor; the annular piezoelectric actuator leans against the flexible hinge, the force sensor detects a force borne by the tool bit and feeds the force back, and the acceleration sensor detects an acceleration on the flexible hinge and feeds the acceleration back; and an inertia force, an actual cutting force and a tool feed are obtained by calculation.

Further specifically, the flexible hinge is circular, and includes a fixed part located on a circumference, a working part located in a middle, and an elastic part connecting the fixed part and the working part; the fixed part is fixedly connected to the annular base; the force sensor, the tool bit and the acceleration sensor are fixed onto the working part; and the annular piezoelectric actuator leans against the working part.

Further specifically, a cover plate is arranged between the tool bit and the force sensor, the tool bit is fixed onto the cover plate, and the cover plate is fixed onto the working part of the flexible hinge by using a screw passing through the cover plate and the force sensor.

Further specifically, a first positioning slot is formed in an end face of the working part close to the force sensor, and a second positioning slot is formed in an end face of the cover plate close to the force sensor; and the first positioning slot is opposite to the second positioning slot, and the force sensor is arranged in the first positioning slot and the second positioning slot.

Further specifically, the cover plate includes: a top plate for fixing the tool bit, and a baffle extending from two sides of the top plate to the flexible hinge; and the baffle covers the working part; an annular groove is formed in an end of the baffle; and a sealing ring is disposed in the annular groove.

Further specifically, a third positioning slot is formed in an end face of the working part away from the force sensor, and an end of the annular piezoelectric actuator is clamped in the third positioning slot.

Further specifically, the acceleration sensor is arranged on an end face of the flexible hinge away from the force sensor, and is located at a center of the flexible hinge.

The present invention has the following beneficial effects. The cutting force F of the tool bit is detected in real time by the force sensor, the inertia force F2 is obtained through the detection in real time by the acceleration sensor and the calculation, the actual cutting force F is calculated by F−F2 in real time, and meanwhile, the tool feed can be obtained by performing integration calculation in real time on the acceleration detected by the acceleration sensor. The advantages of using the acceleration sensor are that the accuracy is relatively high, the structure is relatively simple, the price is relatively low, and the assembling difficulty and cost of the apparatus can be reduced on the premise of ensuring the detection accuracy.

### BRIEF DESCRIPTION OF THE DRAWINGS

FIG. 1 is a flow chart of a detection method of the present invention;

FIG. 2 is a schematic structural diagram of a cutting apparatus of the present invention;

FIG. 3 is a schematic structural diagram of a flexible hinge of the present invention; and

FIG. 4 is a schematic structural diagram of a cover plate of the present invention.

In drawings, reference numerals represent the following components: 1, acceleration sensor; 2, annular piezoelectric actuator; 3, flexible hinge; 4, force sensor; 5, cover plate; 6, tool bit; 7, annular base; 31, fixed plate; 32, working part; 33, elastic part; 34, a first positioning slot; 35, a third positioning slot; 51, top plate; 52, baffle; 53, second positioning slot; and 54, annular groove.

### DETAILED DESCRIPTION

The present invention will be described in detail below with reference to specific embodiments shown in the accompanying drawings. However, these embodiments do not limit the present invention. Structural, methodological or functional variations made by those skilled in the art based on these embodiments are all included in the protection scope of the present invention.

In the various drawings of the present invention, some dimensions of the structures or parts may be exaggerated relative to other structures or parts for convenience of illustration, and therefore they are only used to illustrate basic structures of the subject matter of the present application.

For the convenience of description, this application uses terms representing the relative positions in space for description, such as “upper”, “lower”, “rear”, “front”, etc., which are used to describe the relationship of one unit or feature shown in the drawings relative to another unit or feature. The terms describing the relative positions in space may comprise different orientations of the equipment in use or operation other than the orientations shown in the drawings. For example, if a device in the drawings is turned over, the unit described as being “below” or “above” other units or features will be positioned “above” or “below” the other units or features. Therefore, the exemplary term “below” can encompass both spatial orientations of “below” and “above”. The device can be oriented in other ways (rotated 90 degrees or at other orientations) and interpret the space-related descriptors used herein accordingly.

The present invention will be described in detail below with reference to the accompanying drawings.

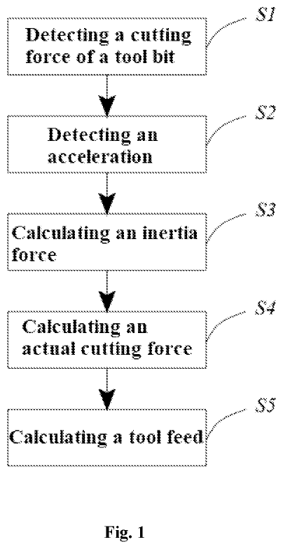

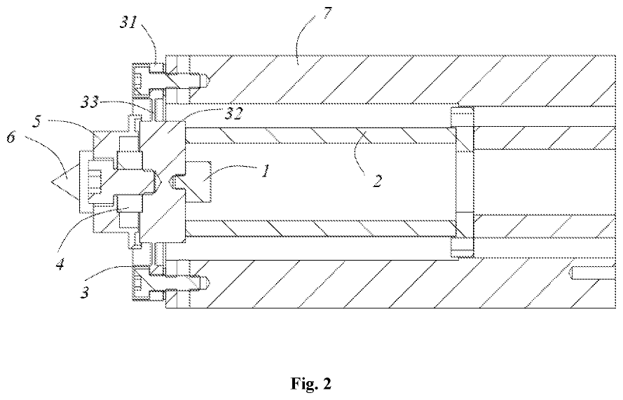

As shown in FIGS. 1 and 2, a composite intelligent detection method is configured to detect a cutting force and a tool cutting feed of a fast tool servo cutting apparatus. The method includes the following steps.

In S1, a cutting force of a tool bit is detected. The cutting force is directly acquired by a force sensor 4 in the cutting apparatus; the force sensor 4 is mounted inside the cutting apparatus, wherein it is required that at the mounting position, the force sensor 4 can receive a counter-acting force transmitted from the tool bit 6; and the detected counter-acting force is the cutting force F of the tool bit, while the obtained cutting force F of the tool bit is obtained by accumulating an actual cutting force F1 and an inertia force F2, so it is required to obtain the actual cutting force F1 and the inertia force F2.

In S2, an acceleration is detected, wherein the acceleration is acquired by an acceleration sensor 1 arranged in the cutting apparatus.

In S3, an inertia force is calculated, wherein the inertia force is obtained by acquiring a moving mass on the force sensor 4 and calculating by Equation 1:

F2=M×a Equation 1,

wherein F2 represents the inertia force, M represents the moving mass, and a represents the acceleration; and the acceleration a is obtained by the acceleration sensor 1 in step S2, and the moving mass can be directly obtained after the cutting apparatus is molded, and thus, is a fixed value.

The moving mass is a sum of the masses of objects that are arranged between the force sensor 4 and an object to be cut and that directly and indirectly act on the force sensor 4. For example, the tool bit 6, the cover plate 5 for fixing the tool bit 6, a screw and other objects are fixed onto the force sensor 4 in a direct fixing or indirect fixing manner. Direct fixing indicates that objects such as the cover plate 5 are directly fixed onto the force sensor 4 by the screw; and indirect fixing indicates that objects such as the tool bit 6 are fixed onto the cover plate 5 while the cover plate 5 is fixed onto the force sensor 4.

In S4, an actual cutting force is calculated by Equation 2:

F1=F−F2 Equation 2,

wherein F represents the cutting force of the tool bit, F1 represents the actual cutting force, and F2 represents the inertia force.

Through the above three steps, the cutting force F of the tool bit is measured by the force sensor 4 in step S1, and the inertia force F2 is calculated by step S3.

In S5, a tool feed is calculated, wherein the tool feed can be obtained by performing double integral operation on the acceleration value obtained in step S2, and is calculated by Equation 3 and Equation 4:

V=∫₀^{t}adt Equation 3; and

S=∫₀^{t}Vdt Equation 4,

wherein a represents the measured acceleration, V represents a speed, and S represents the tool feed.

The calculation in the above steps S1 to S5 can be realized by a computer, and the synchronous calculation can be almost realized.

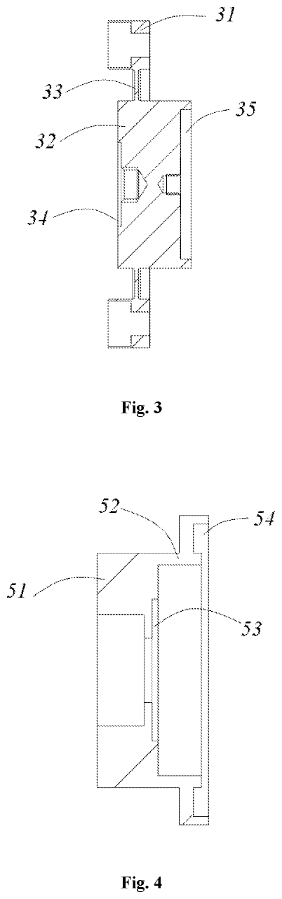

An intelligent cutting apparatus is designed based on the above composite intelligent detection method. As shown in FIG. 2, the cutting apparatus includes an annular base 7, a tool bit assembly arranged at one end of the annular base 7, and an annular piezoelectric actuator 2 fixed inside the annular base 7 and abutting against the tool bit assembly. The tool bit assembly includes a flexible hinge 3 fixed at an end of the annular base 7, an acceleration sensor 2 fixed onto the flexible hinge 3, a force sensor 4 fixed onto the flexible hinge 3, and a tool bit 6 arranged on the force sensor 4. As shown in FIG. 3, the flexible hinge 3 for the cutting apparatus is circular, and includes an annular fixed part 31 located on a circumference, a working part 32 located in the middle of the annular fixed part 31, and an elastic part 33 arranged in a radial direction of the flexible hinge 3. The elastic part 33 is used for connecting the fixed part 31 and the working part 32. The fixed part 31 is fixed onto an end face of the annular base 7 by a screw. The tool bit 6 may be directly fixed onto the force sensor 4 or indirectly fixed onto the force sensor 4 in other manners. The annular piezoelectric actuator 2 leans against the working part 32 of the flexible hinge 3, the force sensor 4 detects a force borne by the tool bit 6 and feeds the force back, and the acceleration sensor 1 detects an acceleration on the flexible hinge 3 and feeds the acceleration back. An inertia force, an actual cutting force and a tool feed are obtained by calculating the two feedbacks through a computer.

During machining by cutting, the cutting force completely acts on the working part 32 of the flexible hinge 3. Thus, in order to improve the measurement accuracy, both the force sensor 4 and the acceleration sensor 1 are required to be mounted in the working part 32 of the flexible hinge 3. The force sensor 4 is arranged on the outer side of the working part 32, namely, an end face of the side of the working part 32 close to an object to be cut, and the acceleration sensor 1 is arranged on the inner side of the working part 32, namely, on an end face of the side of the working part 32 away from the object to be cut. The cover plate 5 is arranged between the tool bit 6 and the force sensor 4, the tool bit 6 is fixed onto the cover plate 5, and the cover plate 5 is fixed onto the working part 32 of the flexible hinge 3 by using the screw passing through the cover plate 5 and the force sensor 4. As shown in FIG. 4, the cover plate 5 consists of two parts, including a top plate 51 for fixing the tool bit 6 and a baffle 52 extending from two sides of the top plate 51 to the flexible hinge 3. The baffle 52 covers the working part 32 and is not in contact with the working part 32. An annular groove 54 is formed in an end of the baffle 52, and a rubber sealing ring is disposed in the annular groove 54. The top plate 51 is mainly used for facilitating the fixed connection of the tool bit 6, and the baffle 52 is mainly used for preventing waste debris and cutting fluid in the cutting process from adversely affecting the force sensor 4. The use of the rubber sealing ring can isolate the force sensor 4 from an external cutting environment and prolong the service life of the force sensor 4.

In the aspect of the positioning of the force sensor 4 and the annular piezoelectric actuator 2, as shown in FIG. 3, a first positioning slot 34 is formed in an end face of the working part 32 close to the force sensor 4; and as shown in FIG. 4, a second positioning slot 53 is formed in an end face of the cover plate 5 close to the force sensor 4. The first positioning slot 34 is opposite to the second positioning slot 53; and the force sensor 4 is arranged in the first positioning slot 34 and the second positioning slot 53, and is fixed onto the working part 32 by applying a pre-tightening force through screws. The first positioning slot 34 and the second positioning slot 53 may also be slightly larger than the two end faces of the force sensor 4. The sizes and the positions of the first positioning slot 34 and the second positioning slot 53 are determined according to an actual size of the force sensor 4. In this solution, the force sensor 4 is cylindrical in shape and positioned in the center of the working part 32. A third positioning slot 35 is formed in an end face of the working part 32 away from the force sensor 4. An end of the annular piezoelectric actuator 2 is clamped in the third positioning slot 35, the third positioning slot 35 is circular or annular, and the end of the annular piezoelectric actuator 2 and the third positioning slot 35 are tightly fixed by insulating glue. The acceleration sensor 1 is arranged on the working part 32 of the flexible hinge 3 and is disposed on an end face of the working part 32 away from the force sensor 4; and the acceleration sensor 1 is located at the center of the flexible hinge 3.

In this solution, the moving mass mentioned in the detection method is a sum of the masses of the tool bit 6, the cover plate 5 and the screws for fixing the tool bit 6 and the cover plate 5, and thus, can be obtained after the cutting apparatus is assembled completely.

In summary, through the above detection method and the cutting apparatus designed based on the detection method, the acceleration in the machining process can be detected in real time by the acceleration sensor 1, so as to calculate the accurate inertia force value; the accurate actual cutting force F1 is calculated by F1=F-F2, both the cutting force F of the tool bit and the inertia force F2 can be obtained in real time, and thus, the actual cutting force F1 is more accurate and can be obtained in real time; the tool feed in the machining process is obtained by performing integration operation on the acceleration, without needing a displacement sensor; and the acceleration sensor 1 is easy to mount and only needs to be fixed onto the flexible hinge 3, without high-accuracy matching like the displacement sensor, thereby reducing the whole machining difficulty, assembling difficulty and cost of the mechanism.

It should be noted that the above embodiments are only the preferred embodiments of the present invention, and do not limit the present invention in any form. Any simple modifications, equivalent changes and modifications made to the above embodiments according to the technical essence of the present invention still fall within the scope of the technical solutions of the present invention.

1: A composite intelligent detection method for detecting a cutting force and a tool cutting feed of a fast tool servo cutting apparatus, the method comprising the steps of:
S1, detecting a cutting force of a tool bit, wherein the cutting force is directly acquired by a force sensor in the cutting apparatus;
S2, detecting an acceleration, wherein the acceleration is acquired by an acceleration sensor arranged in the cutting apparatus;
S3, calculating an inertia force, wherein the inertia force is obtained by acquiring a moving mass on the force sensor and calculating by Equation 1:
F2=M×a Equation 1;
wherein F2 represents the inertia force, M represents the moving mass, and a represents the acceleration;
S4, calculating an actual cutting force by Equation 2:
F1=F−F2 Equation 2;
wherein F represents the cutting force of the tool bit, F1 represents the actual cutting force, and F2 represents the inertia force; and
S5, calculating a tool feed, wherein the tool feed is obtained by performing integration operation on the acceleration.

2: The composite intelligent detection method according to claim 1, wherein the moving mass is a sum of masses of objects that are arranged between the force sensor and an object to be cut and that directly and indirectly act on the force sensor.

3: A cutting apparatus based on the composite intelligent detection method according to claim 1, comprising: an annular base, a tool bit assembly arranged at one end of the annular base, and an annular piezoelectric actuator fixed inside the annular base and abutting against the tool bit assembly, wherein the tool bit assembly comprises a flexible hinge fixed at an end of the annular base, an acceleration sensor fixed onto the flexible hinge, a force sensor fixed onto the flexible hinge, and a tool bit arranged on the force sensor; the annular piezoelectric actuator leans against the flexible hinge, the force sensor detects a force borne by the tool bit and feeds the force back, and the acceleration sensor detects an acceleration on the flexible hinge and feeds the acceleration back; and an inertia force, an actual cutting force and a tool feed are obtained by calculation.

4: The cutting apparatus according to claim 3, wherein the flexible hinge is circular, and comprises a fixed part located on a circumference, a working part located in a middle, and an elastic part connecting the fixed part and the working part; the fixed part is fixedly connected to the annular base; the force sensor, the tool bit and the acceleration sensor are fixed onto the working part; and the annular piezoelectric actuator leans against the working part.

5: The cutting apparatus according to claim 4, wherein a cover plate is arranged between the tool bit and the force sensor, the tool bit is fixed onto the cover plate, and the cover plate is fixed onto the working part of the flexible hinge by using a screw passing through the cover plate and the force sensor.

6: The cutting apparatus according to claim 5, wherein a first positioning slot is formed in an end face of the working part close to the force sensor, and a second positioning slot is formed in an end face of the cover plate close to the force sensor; and the first positioning slot is opposite to the second positioning slot, and the force sensor is arranged in the first positioning slot and the second positioning slot.

7: The cutting apparatus according to claim 5, wherein the cover plate comprises: a top plate for fixing the tool bit, and a baffle extending from two sides of the top plate to the flexible hinge; and the baffle covers the working part; an annular groove is formed in an end of the baffle; and a sealing ring is disposed in the annular groove.

8: The cutting apparatus according to claim 4, wherein a third positioning slot is formed in an end face of the working part away from the force sensor, and an end of the annular piezoelectric actuator is clamped in the third positioning slot.

9: The cutting apparatus according to claim 3, wherein the acceleration sensor is arranged on an end face of the flexible hinge away from the force sensor, and is located at a center of the flexible hinge.
